(19) United States
(12) Patent Application Publication
(10) Pub. No.: US 2018/0335501 A1
(43) Pub. Date: Nov. 22, 2018

(54) METHOD AND SYSTEM FOR INDOOR LOCALIZATION OF A MOBILE DEVICE

(71) Applicant: Nokia Technologies OY, Espoo (FI)

(72) Inventor: Yejian CHEN, Stuttgart (DE)

(21) Appl. No.: 15/600,024

(22) Filed: May 19, 2017

(51) Int. Cl. G01S 5/00

(52) U.S. Cl. CPC G01S 5/0018; G01S 5/009; G01S 5/0081

(57) ABSTRACT

Localization of the mobile device uses a non-orthogonal multiple access (NOMA) scheme involving base stations, where localization is accomplished by sending a positioning request to the base stations, and receiving base station coordinate information and direction of arrival (DoA) information from the base stations. Distance information is computed based on the base station coordinate information. A location of the mobile device is determined based on the DoA information and the distance information.

### BACKGROUND OF THE INVENTION

### Field of the Invention

Example embodiments relate generally to a method and a system for localization of a mobile device using a wireless communication network, especially in scenarios where the mobile device has an extremely low transmission and/or reception power.

### Related Art

Global Positioning System (GPS) is a popular approach to localizing a mobile terminal device. However, in an indoor environment, a satellite signal may be significantly shadowed, which may cause global navigation satellite systems (GNSS), such as a global positioning system (GPS), to be ineffective in locating a mobile device indoors. An indoor wireless local area network (WLAN) may also be used to localize a mobile device indoors, though a precision of a WLAN is not always certain, and an availability of a WLAN cannot be relied upon especially in the event of a disaster scenario.

Mobile devices with low transmission and/or reception power may also be particularly difficult to localize a mobile terminal device using GPS, WLAN, or other localization schemes. Furthermore, noise and interference from other mobile devices can degrade a signal-to-interference and noise-ratio (SINR), which may limit signal processing techniques, making indoor localization a further challenge. Other technologies, such as radio frequency identification (RFID), ultra-wideband (UWB) and/or wireless sensor networks (WSN), all require dedicated infrastructure with significant resources and costs for use in localization of mobile devices.

### SUMMARY OF INVENTION

At least one example embodiments relates to a method of localization of a mobile device using a non-orthogonal multiple access (NOMA) scheme involving at least two base stations.

In an embodiment, the method includes sending, by at least one first processor of the mobile device, a positioning request to the at least two base stations; receiving, by the at least one first processor, base station coordinate information and direction of arrival (DoA) information from the at least two base stations; computing, by the at least one first processor, distance information based on the base station coordinate information, the distance information representing one or more physical distances between the at least two base stations; and determining, by the at least one first processor, a location of the mobile device based on the DoA information and the distance information.

In an embodiment, the mobile device is located in an indoor location.

In an embodiment, the method is performed without the support of a global navigation satellite system (GNSS), and without the support of a wireless local area network (WLAN).

In an embodiment, the method is performed using uncoordinated base stations.

At least another example embodiment relates to a network node in communication with at least two base stations that have adopted a non-orthogonal multiple access (NOMA) scheme.

In an embodiment, the network node includes a memory storing computer-readable instructions; and at least one processor configured to execute the computer-readable instructions such that the at least one processor is configured to, send a positioning request to at least two base stations, receive base station coordination information and direction of arrival (DoA) information from the at least two base stations, compute distance information based on the base station coordinate information, the distance information representing one or more physical distances between the at least two base stations, and determine a location of the mobile device based on the DoA information and the distance information.

In an embodiment, the mobile device is located in an indoor location.

In an embodiment, the mobile device is located in an indoor location.

In an embodiment, the location of the mobile device is determined without the support of a global navigation satellite system (GNSS), and without the support of a wireless local area network (WLAN).

In an embodiment, the location of the mobile device is determined using uncoordinated base stations.

At least another example embodiment relates to a non-transitory computer readable medium in which computer program code is stored, the computer program code causing at least one first processor of a mobile device to perform instructions.

In an embodiment, the instructions include sending a positioning request to the at least two base stations, the at least two base stations implementing a non-orthogonal multiple access (NOMA) scheme; receiving base station coordinate information and direction of arrival (DoA) information from the at least two base stations; computing distance information based on the base station coordinate information, the distance information representing one or more physical distances between the at least two base stations; and determining a location of the mobile device based on the DoA information and the distance information.

At least another example embodiment relates to a computer program code configured to perform a method when executed by the at least one first processor.

In an embodiment, the method includes sending a positioning request to the at least two base stations, the at least two base stations implementing a non-orthogonal multiple access (NOMA) scheme; receiving base station coordinate information and direction of arrival (DoA) information from the at least two base stations; computing distance information based on the base station coordinate information, the distance information representing one or more physical distances between the at least two base stations; and determining a location of the mobile device based on the DoA information and the distance information.

In an embodiment, the computer program code is stored on a computer readable storage medium.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 illustrates a localization system, in accordance with an example embodiment;

FIG. 2 illustrates a base station, in accordance with an example embodiment;

FIG. 3 illustrates a reconfigured mobile device, in accordance with an example embodiment;

FIG. 4 illustrates a localization method, in accordance with an example embodiment;

FIG. 5 illustrates another localization system, in accordance with an example embodiment; and

FIG. 6 illustrates a USB memory stick, in accordance with an example embodiment.

### DETAILED DESCRIPTION

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium, such as a non-transitory storage medium. A processor(s) may perform the necessary tasks.

Specific structural and functional details disclosed herein are merely representative for purposes of describing example embodiments. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be any non-transitory storage medium such as magnetic, optical, or flash memory, etc. Similarly, the transmission medium may be twisted wire pairs, coaxial cable, optical fiber, or some other suitable transmission medium known to the art. The example embodiments not limited by these aspects of any given implementation.

General Methodology:

Example embodiments relate to localization of a mobile terminal device, especially in cases where the mobile terminal device may be located indoors, and the mobile terminal device may have an extremely low transmission and or reception power. The receive signal component from a single BS may suffer from an additive noise as strong as 500% to 600% of its own RX power, and may additionally suffer from an interference component up to 500% of its own RX power. The localization scheme may be used to locate the mobile device without assistance from a global navigation satellite system (GNSS), such as a global positioning system (GPS), and without the assistance of an indoor wireless local area network (WLAN), in order to locate the mobile device. In particular, existing cellular networks, utilizing base stations equipped with massive antenna arrays with high sensitivity, may be used to precisely estimate a location of the mobile terminal device.

In example embodiments, the mobile terminal may exploit Interleave Division Multiple Access (IDMA), as defined by Ping, Li, Liu, Lihai, Wu, Keying, Leung, W. K., “Interleave-Division Multiple Access,” IEEE Trans. Wireless Communi., Vol. 5, No. 4, P. 938-347, April 2006, where the mobile terminal may be a candidate for a Non-Orthogonal Multiple Access (NOMA) scheme (especially within a 5G network scheme), where the IDMA is well-known for providing robust performance for asynchronous communications. Link level simulations have demonstrated precision in localization even at low Signal-to-Noise Ratio (SNR) conditions.

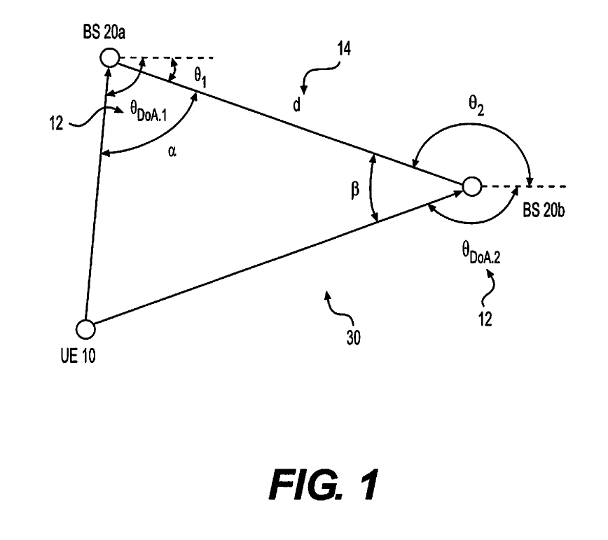

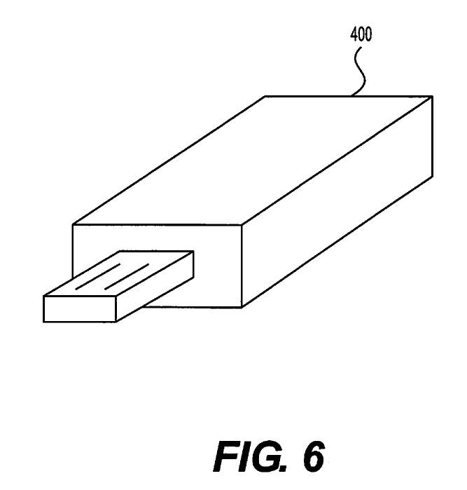

In example embodiments, the system architecture (shown in FIGS. 1 and 6, and described below) may be uncoordinated systems. Meaning, the BSs may operate independently. Due to developments in wireless communication, such as 5G new radio standard, an exploitation of massive antenna elements at BSs may generally guarantee a precise angle of arrival (or “AoA,” which is also referred to as a direction of arrival, or “DoA,” within this document) estimation through uplink. Each BS may encode the DoA information, along with its own coordinates, as 80 key bits. For the same purpose, in order to reduce control signaling, only repetition coding and layer-specific interleaving may be taken into account. The mobile device may deploy downlink IDMA to separate the signals and detect the DoA and BS coordinates. In this uncoded IDMA system, which may be limited by 5 iterations, the computational requirement is affordable. Numerical results demonstrate that it is possible to reach a positioning accuracy within one meter, through the use of 1000-bit or 2500-bit small packet communications. According to the numerical results, 90% of localization activities may fulfill a positioning error, which may be as low as −7 dB to −8 dB. A trade-off between performance and complexity may be considered by introducing a forward error correction (FEC) code, and further shortening the packet length simultaneously.

It should be understood that, conventional orthogonal multiple access (MA) schemes (e.g. CDMA, TDMA, and FDMA) are not preferred for localization, as these schemes require precise scheduling to fulfill the localization requirements, due to a need for synchronous communications with these schemes. Without the scheduling, a performance of conventional MA schemes for purposes of localization cannot be guaranteed. With low transmission (TX) and reception (RX) power, a precise scheduling also cannot be expected. Therefore, in the instant example embodiments, the signaling overhead may be significantly reduced. For instance, a FEC coding may be unnecessary. A spreading may instead be replaced by repetition. Thus, there is no need to exchange such information between TX and RX. Additionally, using the adopted NOMA scheme, such as IDMA, the example embodiments may support asynchronous communications. The quality of data detection may not be influenced by an individual signal's time of arrival. These aspects therefore provide a robustness offered by NOMA for purposes of localization.

Signal Model:

In an embodiment, synchronization between a user equipment (UE) and base station (BS) is necessary especially for preamble transmission. The preamble patterns may be selected from an orthogonal basis, e.g. Walsh-Hadamard matrix, Discrete Fourier Transform (DFT) matrix. Once a code from the orthogonal basis is selected by BS k (from within a plurality of base stations), the code may be mapped to a time-frequency resource in the preamble zone. The permutation mapping rule is a priori known by the BS k and the mobile device. The preamble may be utilized by the UE to detect the activity from BS k. Furthermore, a successfully detected preamble may embrace control information, such as Modulation and Coding Scheme (MCS) or interleaving pattern, in one-to-one correspondence. The BS k may select its interleaving pattern sporadically. The collision probability Pc, that at least two BSs select the same interleaving pattern unfortunately, can be computed as follows.

$${P}_{c} = 1 - \frac{{P}_{K}^{N}}{{U}_{K}^{N}} = 1 - \frac{{Π}_{k = 1}^{K} ( N + 1 - k )}{{N}^{K}} \qquad ( Eq . 1 )$$

Where N may denote a number of candidates for the preamble patterns, and K may denote a number of BSs sending localization response to the mobile device. In order to suppress the collision probability Pc, each BS may select M preamble patterns independently in another time-frequency allocation in a preamble zone. The same data signal will be independently interleaved and superimposed in a same time-frequency allocation in data zone. For instance, with M=2 preamble patterns per BS, the collision probability will be reduced to 1.26% and 0.33%, by exploiting a preamble set with 128 candidates and 256 candidates, respectively.

Regarding a detection for non-orthogonal superposition of K users (i.e., K UEs) data signal, for a K-layer IDMA system, the system equation may be given as follows:

$$y = d + z = {\sum }_{k = 1}^{K} {h}_{k} {x}_{k} + z \qquad ( Eq . 2 )$$

Where hk may denote a wireless channel between k-th BS and the UE, and z may denote an Additive White Gaussian Noise (AWGN) with noise power spectral density N₀=2σ². A Wide-Sense Stationary Uncorrelated Scattering (WSSUS) channel may be adopted to model a channel response, where the channel modeling may be performed as disclosed in Hoeher, P., “A Statistical Discrete-Time Model for the WSSUS Multipath Channel,” IEEE Trans. Veh. Technol., Vol. 41, No. 4, p. 461-468, November 1992. The model for the channel response at a discrete time instant n between BS k and the UE may be determined as follows.

$${h}_{k} [ n ] = \frac{1}{\sqrt{L}} {\sum }_{j = 0}^{L - 1} exp [ \sqrt{- 1} \cdot ( {ϕ}_{j}^{( k )} + 2 π {f}_{Dj}^{( k )} n ) ] \qquad ( Eq . 3 )$$

Where L denotes a number of propagation paths, φⱼ^{(k)} may stand for a uniformly distributed phase, and f_{D,j}^{(k)} may be a random variable given by Jake's power spectral density. A corresponding auto-correlation function may be determined as follows.

Rₙ= [symbol] ₀(2πTₛf_{D}n) (Eq. 4)

Where the [symbol] ₀(⋅) may denote a Bessel function of order zero, Ts may denote a symbol duration, fD may be a maximal Doppler shift and TsfD may characterize a speed of channel variation, and thus may be denoted as normalized fading rate. Further, the channel coefficients hk may obey independent and identically distributed (i.i.d.) complex Gaussian distributions (i.e., hₖ˜ [symbol] (0, 1)).

Channel Estimation:

For downlink synchronous communications, discrete pilots may be considered, especially for indoor mobile devices with generally low mobility. Nevertheless, due to potentially different Time of Arrival (ToA) in indoor environment, the synchronous communications may usually not be realized. Thus, discrete pilots may be contaminated by data signal or other unwanted interference. Superimposed pilots may be capable of combating against the asynchronous effect. A superimposed pilot based channel estimation may be demonstrated for NOMA in respective single carrier and multicarrier systems, as described in the following documents: Chen, Yejian, Wild, T., Schaich, F., “Trellis-Based Channel Estimation For Asynchronous IDMA With Superimposed Pilots,” in Proc. of IEEE/CIC Int. Conf. Commun. (ICCC'14), pp. 539-543, October 2014, and Chen, Yejian, “Two-Dimensional Pilot Design for Non-Orthogonal Multiple Access in Multicarrier System,” in Proc. of IEEE Globecom Workshops (GC Wkshps), December 2016.

Interleaving-Based Multiple Access:

Interleave Division Multiple Access (IDMA) is an example of a solution, among the interleaving-based multiple access schemes, which may be relied upon in the instant example embodiments. IDMA may exploit both narrow sense code and wide sense codes (e.g. repetition code or spreading code), which may be implemented jointly with layer-specific interleaving. A significant benefit of IDMA, is an Elementary Signal Estimator (ESE), which may establish a statistics-based soft Parallel Interference Cancellation (PIC) processing chain, iteratively. Being supported by central limit theorem, a superposition of multiple signal layers may make the Gaussian Approximation (GA), such like ESE, operate more effectively, even if the number of the layers increases. Extrinsic information delivered by ESE may be determined, as follows.

$${ℒ}_{ESE , k}^{c} [ n ] = log [ \frac{p ( y [ n ] \vert {x}_{k} [ n ] = + 1 )}{p ( y [ n ] \vert {x}_{k} [ n ] = - 1 )} ] \qquad ( Eq . 5 )$$

Where p(y[n]) may denote a conditional Probability Density Function (PDF) for receive signal y estimated and improved through iteration. A channel decoder may be conditionally excluded from the iteration, in order to reduce computational requirements. Hence, the extrinsic information produced by a despreader will be feedback to ESE, and may be determined as follows.

$${ℒ}_{DES , k}^{c} [ \tilde{n} ] = s [ g ( \tilde{n} ) ] {\sum }_{g ( \tilde{n} ) = 1}^{G} s [ g ( \tilde{n} ) ] {ℒ}_{ESE , k}^{c} [ g ( \tilde{n} ) ] - {ℒ}_{ESE , k}^{c} [ \tilde{n} ] . \qquad ( Eq . 6 )$$

Where G may denote a spreading or repetition length, ñ may stand for an index n after de-interleaving, and s[g(ñ)] may represent a spreading or repetition pattern with respect to the g-th chip relating to symbol ñ. By involving a channel decoder to the iteration loop, the channel decoder may help speed up the iteration to approach the convergence, as a trade-off between the complexity and performance.

Coordinate Computation:

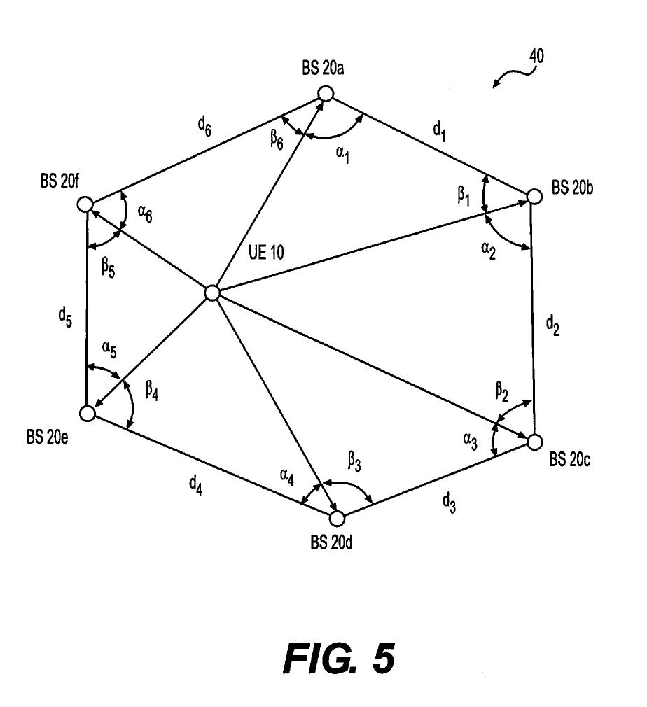

A location of a mobile device may be determined by the DoA and coordinates of at least two BSs. As shown in FIGS. 1 and 5 (described below), for the available parameters associated with BS 20a and BS 20b, namely θ_{DoA,1}, θ_{DoA,2}, x₁, y₁, x₂ and y₂, a coordinate of the mobile device may be determined as follows.

$$\begin{matrix}X = \frac{{y}_{1} - {y}_{2} - ( {t}_{1} {x}_{1} - {t}_{2} {x}_{2} )}{{t}_{2} - {t}_{1}} & ( Eq . 7 ) \\ Y = \frac{{t}_{1} {t}_{2} ( {x}_{2} - {x}_{1} ) + {t}_{2} {y}_{1} - {t}_{1} {y}_{2}}{{t}_{2} - {t}_{1}} & ( Eq . 8 )\end{matrix}$$

With t₁=tan(θ_{DoA,1}), t₂=tan(θ_{DoA,2}), and t₁≠t₂ FIGS. 1 and 5 also illustrates that k−1 coordinate estimates may be obtained, based on the triangle ΔO₁OOₖ, ΔO₂OOₖ, . . . , ΔOₖ₋₁OOₖ, if BS k is added for coordinate estimation. Furthermore, once an indoor mobile device receives signal from K different BSs, a total number of possible coordinate estimates may be determined, as follows.

$$N = \frac{K ( K - 1 )}{2} \qquad ( Eq . 9 )$$

This provides an additional opportunity to select the result in a statistical manner, or simply average the observations, which may be determined, as follows.

$$X = \frac{1}{N} {\sum }_{i} {\sum }_{j} \frac{{y}_{i} - {y}_{j} - ( {t}_{i} {x}_{i} - {t}_{j} {x}_{j} )}{{t}_{j} - {t}_{i}} \qquad ( Eq . 10 )$$

$$Y = \frac{1}{N} {\sum }_{i} {\sum }_{j} \frac{{t}_{i} {t}_{j} ( {x}_{j} - {x}_{i} ) + {t}_{j} {y}_{i} - {t}_{i} {y}_{j}}{{t}_{j} - {t}_{i}} \qquad ( Eq . 11 )$$

Where i≠j and tᵢ≠tⱼ.

### Specific Example Embodiments

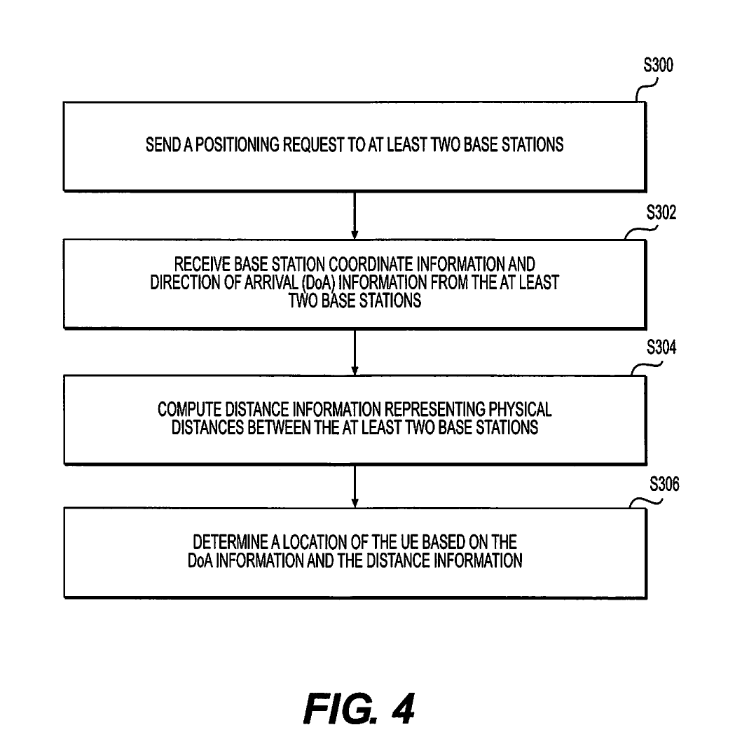

FIG. 1 illustrates a localization system 30, in accordance with an example embodiment. The system may include a mobile device, such as a user equipment (UE) 10, where the mobile device may be in communication with a network, such as a cellular network, where the UE 10 may be capable of communicating with a minimum of two base stations (BS) 20a/20b. If the UE 10 is in a long term evolution (LTE) network, as an example, the BS 20 may be an evolved universal terrestrial radio access (E-UTRA) Node B, or EUTRAN Node B (eNB) base station. In an embodiment, the system 30, the UE 10 may be located indoors. A detailed description of the function and use of the system 30 is provided below in relation to the discussion of the method of FIG. 4.

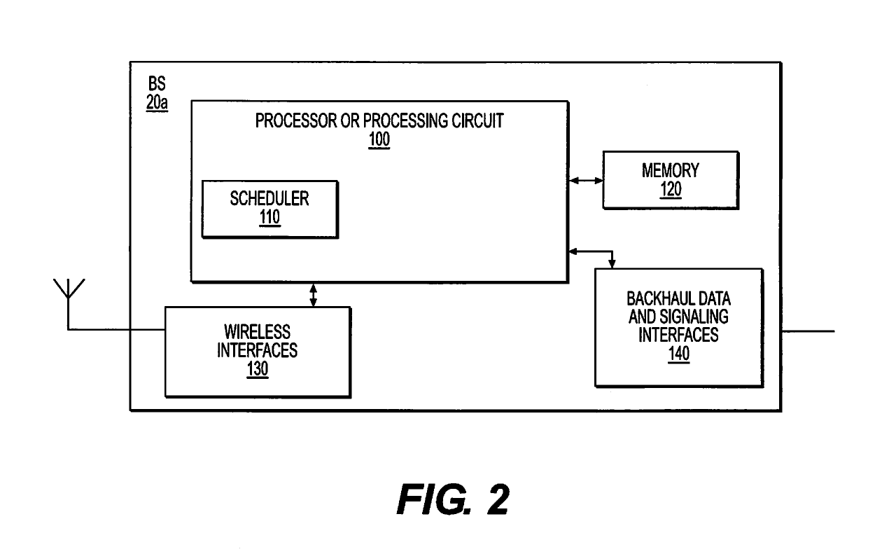

FIG. 2 illustrates a base station (BS) 20a, in accordance with an example embodiment. The BS 20a may be included in the localization system 30 of FIG. 1. The BS 20a may include: a memory 120; a processor 100; a scheduler 110; wireless communication interfaces 130; and a backhaul interface 140. The processor 100 may be closely coupled to the memory 120, and may consist of one or more core processing units, either physically coupled together or distributed. The processor 100 may control a function of the BS 20a (as described herein), and may be operatively coupled to the memory 120 and the communication interfaces 130. While only one processor 100 is shown in FIG. 2, it should be understood that multiple processors may be included in a typical BS 20a. The functions performed by the processor 100 may be implemented using hardware. Such hardware may include one or more Central Processing Units (CPUs), digital signal processors (DSPs), application-specific-integrated-circuits, field programmable gate arrays (FPGAs) computers or the like. The term processor, used throughout this document, may refer to any of these example implementations, though the term is not limited to these examples. With a Virtual Radio Access Network (VRAN) architecture, various functions of a base station, such as eNB components, may be distributed across multiple processing circuits and multiple physical nodes within a VRAN cloud. The BS 20a may include one or more cells or sectors serving the UE 10 within individual geometric coverage sector areas. Throughout this document the terms BS, eNB, cell or sector shall be used interchangeably.

Still referring to FIG. 2, the wireless communication interfaces 130 may include various interfaces including one or more transmitters/receivers connected to one or more antennas to transmit/receive wirelessly control and data signals to/from UE 10, where the BS 20a may serve more than one UE 10. The backhaul interface 140 may be a portion of BS 20a that may be capable of interfacing with other BSs (such BS 20b of FIG. 2), or interface with other network elements and/or radio access network (RAN) elements. The scheduler 110 may schedule control and data communications that may be transmitted and received by the BS 20a to and from UE 10. The memory 120 may buffer and store data that may be processed at BS 20a, as well as transmitted and received to and from BS 20a. It should further be understood that a communication channel, which may be a random access channel (RACH), may enable UE 10 to perform tasks such as initially accessing the communication network, uplink synchronization, handovers between cells, and recovery from failed links.

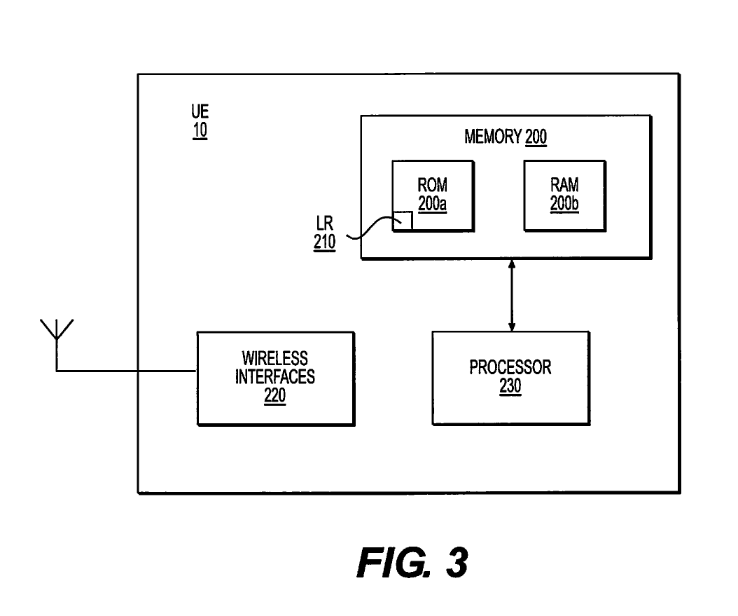

FIG. 3 illustrates a reconfigured mobile device 10, which may be considered a user equipment (EU), in accordance with an example embodiment. The UE 10 may be a cellphone, a laptop, a tablet, or any other type of user terminal device. The UE 10 may include: a processor 230, a memory 200 (which may include ROM 200a and RAM 200b) and a wireless interface 220. The processor 230 may consist of one or more core processing units, either physically coupled together or distributed. The processor 230 may control a function of the UE 10 (as described herein), where the processor 230 may be operatively coupled to the memory 200 and the wireless interface 220. While only one processor 230 is shown in FIG. 3, it should be understood that more than one processor may be included in a typical UE 10.

The memory 200 may include a localization routine (LR) 210 (which may be saved in the ROM 200a), where the LR 210 may include algorithms and instructions that may cause the processor 230 to perform localization, such as the localization method steps described in relation to the method of FIG. 4, described below.

FIG. 4 illustrates a localization method, in accordance with an example embodiment. The method may be performed by the processor 230 of the UE 10 (of FIG. 1), where the processor 230 may access algorithms and instructions within LR 210 (saved to memory 200) that may be used to instruct the processor 230 to perform the method steps shown in FIG. 4. In particular, with regard to step S300, the processor 230 may cause the UE 10 to send a positioning request, where the request may be sent omni-directionally, and the request may be received by the BSs 20a/20b.

In an embodiment, the BSs 20a/20b are not required to estimate a distance to the UE 10, nor do the BSs 20a/20b need to communicate cooperatively with each other, in any way. Instead, each BS 20a/20b may encode its own coordinate (longitude/latitude; “base station coordinate information”) and the Direction of Arrival (DoA) information (described below) within a 80-bit sequence message, which may be sent to the UE 10 (in step S302, described below). In this uplink localization request stage, the asynchronous communications between the UE 10 and the BSs 20a/20b may not influence any precision of a direction of arrival (DoA) estimation. In a downlink positioning stage, the BSs 20a/20b may deliver the control information and data packet in a synchronous mode. Nevertheless, the BSs 20a/20b communication signals may still be asynchronous, and usually may be low-power at the mobile device.

In step S302 of FIG. 4, the processor 230 may receive Direction of Arrival (DoA) information 12, denoted as θ_{DoA,1} and θ_{DoA,2}, from the BSs 20a/20b. That is to say, both BSs 20a/20b may encode their own longitude, latitude and Direction of Arrival (DoA) information θ_{DoA,i}, and transmit this DoA information 12 to the processor 230 of the UE 10.

The information exchange of steps S300 and S302, between the UE 10 and BSs 20a/20b, may be considered an exchange that may effectively create a Downlink Non-Orthogonal Multiple Access (NOMA) system 30, where the system 30 may require the mobile UE 10 to decode the superposition signals (i.e., DoA information) from both BSs 20a/20b. Based on the received DoA information, in step S304, the processor 230 of the UE 10 may then compute distance information 14 (which may be denoted as ‘d’), between both BSs 20a/20b (θ₁ and θ₂, as shown in FIG. 1), where this distance information may represent a physical distance between the BSs 20a/20b.

In step S306 of FIG. 4, the processor 230 of UE 10 may compute the trajectory angles α and β (as shown in FIG. 1), based on the DoA information θ_{DoA,1} and θ_{DoA,2}. Using the trajectory angle information α and β, and the distance information 14, the processor 230 may determine a physical location of the UE 10. It is important to note that this determination of the physical location of UE 10 may be accomplished by the processor 230 without any assistance from a global navigation satellite system (GNSS), such as a global positioning system (GPS), and without the assistance of an indoor wireless local area network (WLAN). The processor 230 may also physically locate the UE 10 without any necessary coordination between the BSs 20a/20b. Meaning, the BS 20a does not need to send information to/from the other BS 20b, nor does the BS 20a need to know the physical location of the other BS 20b, and vice versa. It should be understood that, in a “coordinated localization system,” the BSs will establish a BS-cluster, where the BSs share the BSs' coordinates within the BS-cluster, compute and transmit the location information of mobile device cooperatively.

FIG. 5 illustrates another localization system 40, in accordance with an example embodiment. In this system 40, which differs from the system 30 (FIG. 1) due to an increase in a number of BSs (where system 40 may have six BSs: BS 20a, BS 20b, BS 20c, BS 20d, BS 20e, and BS 20f), each of the BS 20 may respond to a UE 10 positioning request in an identical manner from that described in step S302 (of FIG. 4). That is to say, each BS 20 may respond to the positioning request by sending their longitude, latitude and DoA θ_{DoA,i} (i.e., direction of arrival information) to the UE 10, in order to determine the location of the UE 10 through a triangulation technique. It should be understood, due to an increased number of BS 20, a more accurate location of the UE 10 may be determined, as compared to the system 30 of FIG. 1. It should also be understood that more BS 20 (i.e., more than six), or less BS 20, may be implemented in the system of FIG. 2.

FIG. 6 illustrates a USB memory stick 400, in accordance with an example embodiment. The memory stick 400 is an example of a leader readable medium that may include instructions for a processor, where the instructions may include the method steps shown and described in relation to FIG. 4. In particular, the instructions may be computer code, where the computer code may be configured to cause a processor to perform the instruction steps.

In order to avoid the need for additional control information, a Forward Error Correction (FEC) coding may not be utilized. Furthermore, spreading may be replaced by the repetition. Meaning, all the BSs 20 may use a same repetition pattern. A superimposed pilot may be deployed, for two purposes, namely channel estimation and user-specific interleaving pattern recognition

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the example embodiments. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the example embodiments, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional or custom, may also be included.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A method of localization of a mobile device using a non-orthogonal multiple access (NOMA) scheme involving at least two base stations, comprising:
sending, by at least one first processor of the mobile device, a positioning request to the at least two base stations;
receiving, by the at least one first processor, base station coordinate information and direction of arrival (DoA) information from the at least two base stations;
computing, by the at least one first processor, distance information based on the base station coordinate information, the distance information representing one or more physical distances between the at least two base stations; and
determining, by the at least one first processor, a location of the mobile device based on the DoA information and the distance information,
the method being performed without the support of a wireless local area network (WLAN).

2. The method of claim 1, wherein the mobile device is located in an indoor location.

3. The method of claim 1, wherein the method is performed without the support of a global navigation satellite system (GNSS).

4. The method of claim 1, wherein the method is performed using uncoordinated base stations.

5. A network node in communication with at least two base stations that have adopted a non-orthogonal multiple access (NOMA) scheme, the network node comprising:
a memory storing computer-readable instructions; and
at least one processor configured to execute the computer-readable instructions such that the at least one processor is configured to,
send a positioning request to at least two base stations,
receive base station coordination information and direction of arrival (DoA) information from the at least two base stations,
compute distance information based on the base station coordinate information, the distance information representing one or more physical distances between the at least two base stations, and
determine a location of the mobile device based on the DoA information and the distance information,
wherein the location of the mobile device is determined without the support of a wireless local area network (WLAN).

6. The network node of claim 5, wherein the mobile device is located in an indoor location.

7. The network node of claim 5, wherein the location of the mobile device is determined without the support of a global navigation satellite system (GNSS).

8. The network node of claim 5, wherein the location of the mobile device is determined using uncoordinated base stations.

9. A non-transitory computer readable medium in which computer program code is stored, the computer program code causing at least one first processor of a mobile device to perform instructions, the instructions comprising:
sending a positioning request to the at least two base stations, the at least two base stations implementing a non-orthogonal multiple access (NOMA) scheme;
receiving base station coordinate information and direction of arrival (DoA) information from the at least two base stations;
computing distance information based on the base station coordinate information, the distance information representing one or more physical distances between the at least two base stations; and
determining a location of the mobile device based on the DoA information and the distance information,
wherein the first processor performs the instructions without the support of a wireless local area network (WLAN).

10. A computer program code on a non-transitory computer readable medium configured to perform the method of claim 1 when executed by the at least one first processor.

11. (canceled)
